(19) United States
(12) Patent Application Publication
(10) Pub. No.: US 2023/0011063 A1
(43) Pub. Date: Jan. 12, 2023

(54) VACUUM CLEANER IMPELLER AND DIFFUSER

(71) Applicant: Techtronic Cordless GP, Anderson, SC (US)

(72) Inventor: Steven Kegg, Hickory, NC (US)

(21) Appl. No.: 17/859,903

(22) Filed: Jul. 7, 2022

Related U.S. Application Data
(60) Provisional application No. 63/219,878, filed on Jul. 9, 2021.

(51) Int. Cl. H02K 9/06; H02K 7/14

(52) U.S. Cl. CPC H02K 9/06; H02K 7/14; H02K 2213/03; H02K 2211/03

(57) ABSTRACT

An impeller comprising a hub, a shroud, a plurality of blades, and circumferential outlet. The hub extends to an outer diameter and is rotatable about a longitudinal axis. The should defines an inlet aperture, extends to the outer diameter, and is offset from the hub along the longitudinal axis to define a passageway between the hub and the shroud. The plurality of blades are located between the hub and the shroud, the blades dividing the passageway into a plurality of passages between each of the plurality of blades. The circumferential outlet is between the hub and the shroud adjacent the outer diameter. Airflow is generated by the plurality of blades, the airflow passing along a flow path within each of the plurality of passages. A size of a cross-sectional area perpendicular to the flow path increases linearly along the flow path from the inlet aperture to the circumferential outlet.

### CROSS-REFERENCE TO RELATED APPLICATION

This application claims priority to U.S. Provisional Application No. 63/219,878, filed Jul. 9, 2021, the entire contents of which are incorporated by reference herein.

### FIELD OF THE DISCLOSURE

The present disclosure relates to suction sources, and more particularly to suction sources for vacuum cleaners.

### BACKGROUND

Vacuum systems include suction sources to incite vacuum suction. Traditionally, suction sources are provided as multicomponent motors and housings which are formed as separate components. Some suction sources include peripheral diffusers which diffuse airflow generated by the suction source. This may mitigate operating sound of the suction source.

### SUMMARY

In one aspect, the present disclosure provides a suction source configured for use with a vacuum cleaner, the suction source comprising a motor, an impeller, a cover, a motor end housing, and an integrally formed motor housing. The motor includes a stator and a rotor rotatable about a longitudinal axis relative to the stator by a bearing. The impeller is secured to the rotor. The cover houses the impeller. The motor end housing has an exhaust aperture. The integrally formed motor housing is connected to the motor end housing. The motor end housing includes a first end fixed to the cover, a bearing mount configured to receive the bearing therein and to permit rotation of the rotor relative to the stator, a first wall extending along the longitudinal axis, the first wall having a radially inner surface, a second wall extends along the longitudinal axis, the second wall having a radially outer surface facing the radially inner surface of the first wall, an airflow channel defined between the radially inner surface of the first wall and the radially outer surface of the second wall, the airflow channel configured to pass airflow generated by the impeller from the first end towards a second end, and a plurality of diffuser vanes located within the airflow channel extending between the first wall and the second wall such that, upon operation of the motor, airflow generated by rotation of the impeller passes through the airflow channel and along both the diffuser vane and the motor prior to egress from the suction source by the exhaust aperture adjacent the second end.

In another aspect, the present disclosure provides a suction source configured for use with a vacuum cleaner, the suction source comprising a motor, an impeller, a cover, and a motor housing. The motor includes a stator and a rotor rotatable about a longitudinal axis relative to the stator. The impeller is secured to the rotor. The cover houses the impeller. The motor housing includes a first end fixed to the cover, a second end a second end opposite the first end, the second end having an exhaust aperture, a first wall extending along the longitudinal axis, the first wall has a radially inner surface, a second wall extends along the longitudinal axis, the second wall has a radially outer surface facing the radially inner surface of the first wall, an airflow channel defined between the radially inner surface of the first wall and the radially outer surface of the second wall, the airflow channel configured to pass airflow generated by the impeller from the first end towards the second end, and a diffuser vane located within the airflow channel such that, upon operation of the motor, airflow generated by rotation of the impeller passes through the airflow channel and along both the diffuser vane and the motor prior to egress from the suction source by the exhaust aperture; wherein the diffuser vane has a cross-sectional profile with a leading edge portion having a leading edge adjacent the first end and a trailing edge portion having a trailing edge opposite the leading edge, the leading edge and trailing edge defining a chord therebetween, and wherein the cross-sectional profile of the diffuser vane includes a vane maximum thickness substantially perpendicular to the chord, wherein the trailing edge portion includes a width W2 between 20% and 50% of the vane maximum thickness.

In another aspect, the present disclosure provides an impeller configured for use with a suction source of a vacuum cleaner. The impeller comprises a hub, a shroud, a plurality of blades, and a circumferential outlet. The hub extends to an outer diameter of the impeller and is rotatable about a longitudinal axis. The shroud defines an inlet aperture has an inlet diameter between 45% and 60% of the outer diameter. The inlet aperture is configured to receive fluid. The shroud extends to the outer diameter. The shroud is offset form the hub along the longitudinal axis to define a passageway between the hub and the shroud. The plurality of blades divide the passageway into a plurality of passages between each of the plurality of blades. The circumferential outlet is between the hub and the shroud adjacent the outer diameter. Each of the plurality of passages extends between the inlet aperture and the circumferential outlet. Each of the plurality of passages is subdivided into an inner expansion section and an outer expansion section. The inner expansion section is adjacent to the circumferential outlet. The shroud in the outer expansion section is linearly sloped in a direction extending from the inlet aperture towards the circumferential outlet, the slope of the second expansion section being greater than 2 degrees from perpendicular to the longitudinal axis.

### BRIEF DESCRIPTION OF THE DRAWINGS

FIG. 1 is a perspective view of a suction source configured for use with a vacuum cleaner.

FIG. 2 is another perspective view of the suction source of FIG. 1.

FIG. 3 is a top view of the suction source of FIG. 1.

FIG. 4 is a side view of the suction source of FIG. 1.

FIG. 5 is a cross sectional view of the suction source of FIG. 1 taken along section line 5-5 in FIG. 3.

FIG. 6 is a cross sectional view of the suction source of FIG. 1 taken along section line 6-6 in FIG. 3.

FIG. 7 is a cross sectional view of the suction source of FIG. 1 taken along section line 7-7 in FIG. 3.

FIG. 8 is a perspective view of the cross-sectional view of the suction source of FIG. 7.

FIG. 9A is a side view of diffuser vanes of the suction source of FIG. 7.

FIG. 9B is a side view of a diffuser vane of the suction source of FIG. 7.

FIG. 9C is a side view of a diffuser vane of the suction source of FIG. 7.

FIG. 9D is a perspective view of diffuser vanes of the suction source of FIG. 7.

FIG. 9E is a side view of a diffuser vane of the suction source of FIG. 7 having a trailing edge portion including a trailing surface.

FIG. 9F is a side view of a diffuser vane of the suction source of FIG. 7 taken along section line 9F-9F in FIG. 9E and having a trailing edge portion including a trailing surface.

FIG. 9G is a side view of a diffuser vane of the suction source of FIG. 7 having a trailing edge portion including a rounded edge.

FIG. 9H is a side view of a diffuser vane of the suction source of FIG. 7 having an enlarged width.

FIG. 9I is a side view of a prior art diffuser vane with a prior art cross-sectional profile.

FIG. 10 a cross-sectional view of the suction source of FIG. 1 taken along section line 10-10 in FIG. 4.

FIG. 11 is a cross-sectional view of the suction source of FIG. 1 taken along section line 11-11 in FIG. 4.

FIG. 12 is a cross sectional view of the impeller of the suction source of FIG. 1 taken along section line 12-12 in FIG. 3.

FIG. 13 is a partial cross sectional view of a passage through the impeller of the suction source of FIG. 1 taken along section line 13-13 in FIG. 3.

### DETAILED DESCRIPTION

Before any embodiments of the present disclosure are explained in detail, it is to be understood that the disclosure is not limited in its application to the details of construction and the arrangement of components set forth in the following description or illustrated in the following drawings. The disclosures described herein are capable of other embodiments and of being practiced or of being carried out in various ways.

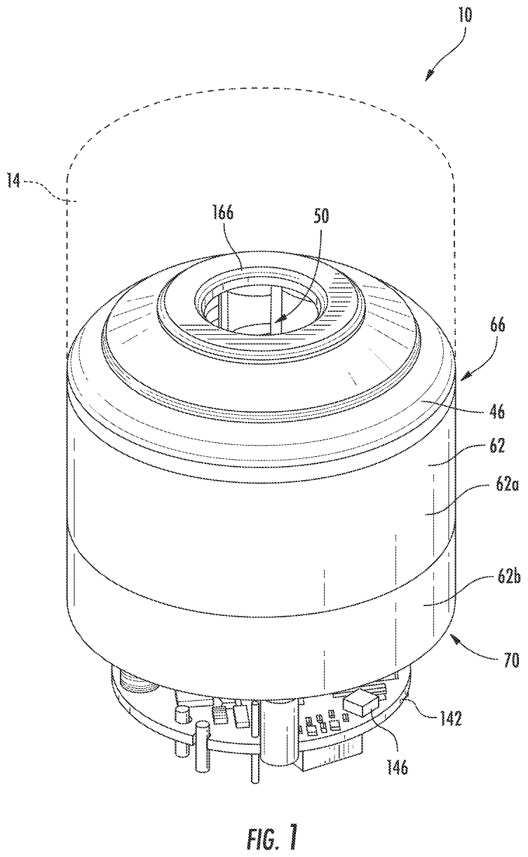

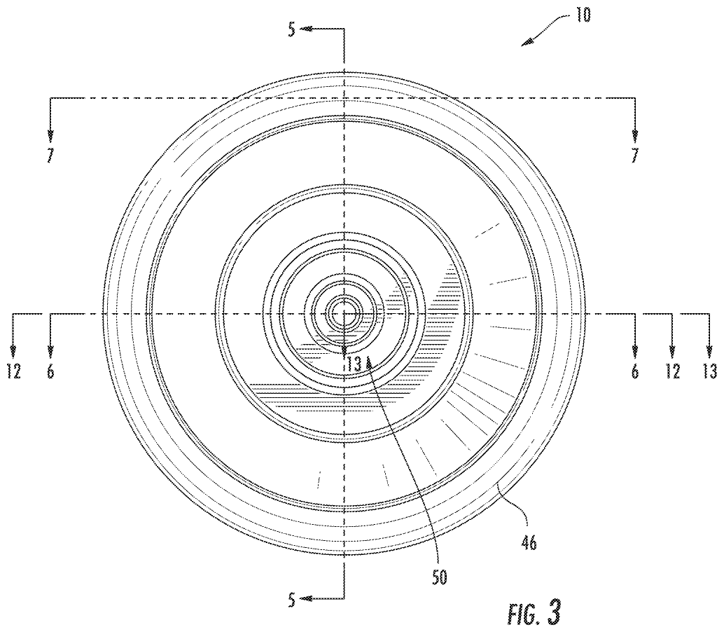

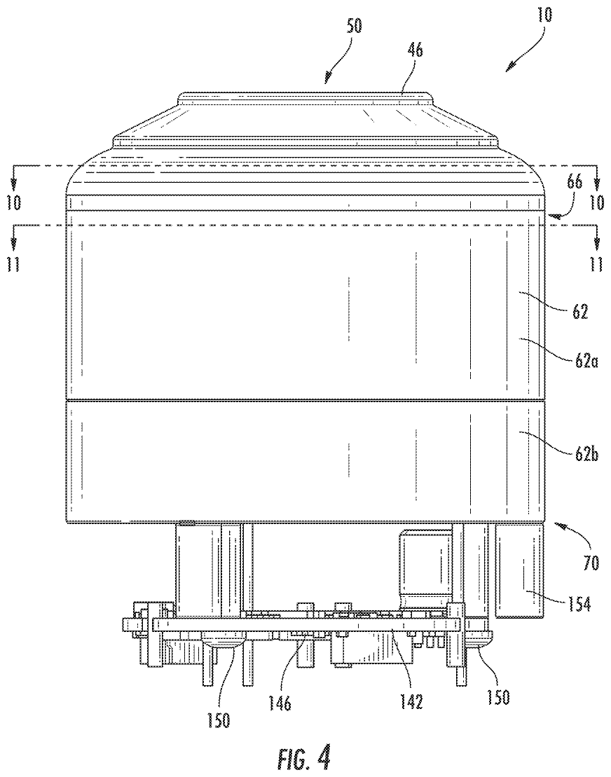

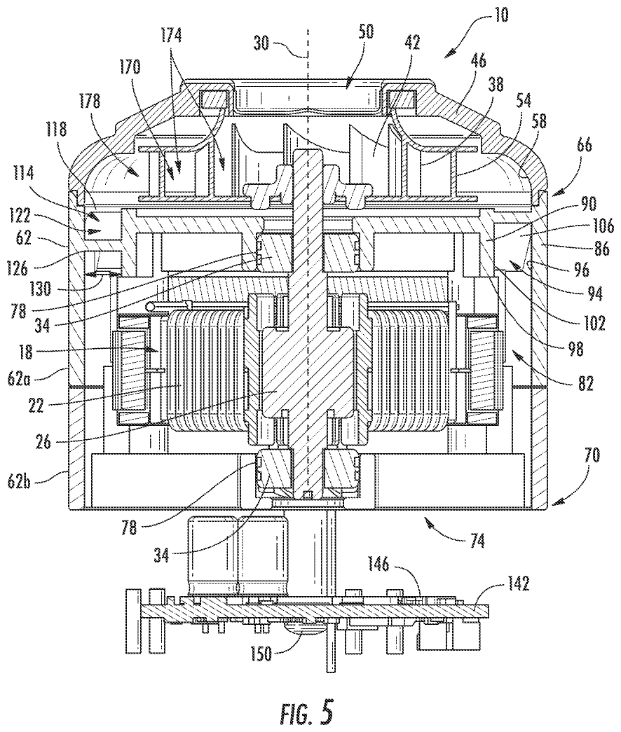

FIGS. 1-4 illustrate a suction source 10 configured for use in a vacuum cleaner 14. The suction source 10 is operable to generate suction airflow for separating debris from clean air in the operation of the vacuum cleaner 14. As best illustrated in FIG. 5, the suction source 10 includes a motor 18 including a stator 22 and a rotor 26. The rotor 26 extends along a longitudinal axis 30. The rotor 26 is rotatable about the longitudinal axis 30 relative to the stator 22 by bearings 34. An impeller 38 is secured to the rotor 26 at one axial end thereof. The impeller 38 includes impeller blades 42 configured to generate suction airflow of the suction source 10 upon operation of the motor 18.

With continued reference to FIG. 5, the suction source 10 includes a cover 46 that houses the impeller 38. The cover 46 has an inlet 50 through which airflow passes upon operation of the motor 18. At the inlet 50, airflow flows generally parallel to the longitudinal axis 30. The impeller blades 42 force airflow inside the cover 46 generally outwardly along a direction transverse to the longitudinal axis 30 to a radial periphery 54 of the impeller 38 adjacent the cover 46. The cover 46 has an inner wall 58 adjacent the radial periphery 54. The inner wall 58 is configured to direct airflow generated by the impeller 38 along the longitudinal axis 30 and away from the inlet 50.

With continued reference to FIG. 5, a motor housing 62 is fixed to the cover 46. The motor housing 62 has a motor first end 66 that is fixed to the cover 46. The motor housing 62 has a motor second end 70 opposite the first end 66, the second end 70 having an exhaust aperture 74. The first end 66 and the second end 70 are axially disposed along the longitudinal axis 30. The motor housing 62 includes an upper bearing mount 78 and a lower bearing mount 78′, each configured to receive the bearings 34 therein and to permit rotation of the rotor 26 relative to the stator 22. The motor housing 62 has a generally hollow interior 82. The motor housing thus has space to house the motor 18. The interior 82 also permits airflow generated by the impeller 38 to carry heat generated by the motor 18 out of the motor housing 62 as it passes from the inlet 50 through the exhaust aperture 74.

With continued reference to FIG. 5, the motor housing 62 includes a first wall 86 and a second wall 90 that defines an airflow channel 94. The airflow channel 94 permits airflow generated by the impeller 38 to pass through the airflow channel 94 generally in a direction from the first end 66 toward the second end 70 into the interior 82 of the motor housing 62. The first wall 86 extends along the longitudinal axis 30. In the illustrated embodiment, the first wall 86 is a cylindrical exterior wall of the suction source 10. The first wall 86 includes a radially inner surface 96 facing the longitudinal axis 30. In the illustrated embodiment, the second wall 90 is a cylindrical interior wall of the motor housing 62 concentric with the first wall 86. The second wall 90 extends along the longitudinal axis 30 from the first end 66 to an intermediate point 98 between the first end 66 and the second end 70. The intermediate point 98 may be located along the longitudinal axis 30 between the stator 22 and the first end 66. In the illustrated embodiment, the intermediate point 98 is downstream of diffuser vanes 106 disposed between the first wall 86 and second wall 90 such that the end of the second wall 90 is upstream of the stator 22. The second wall 90 has a radially outer surface 102 which faces away from the longitudinal axis 30 and towards the radially inner surface 96.

With continued reference to FIG. 5, the airflow channel 94 is defined between the radially inner surface 96 of the first wall 86 and the radially outer surface 102 of the second wall 90. The airflow channel 94 is configured to pass airflow generated by the impeller 38 from the first end 66 towards the second end 70.

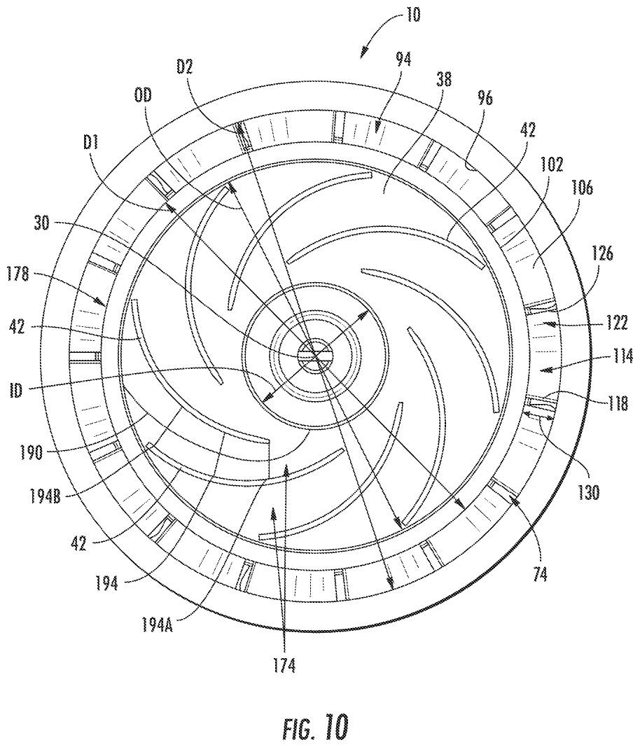

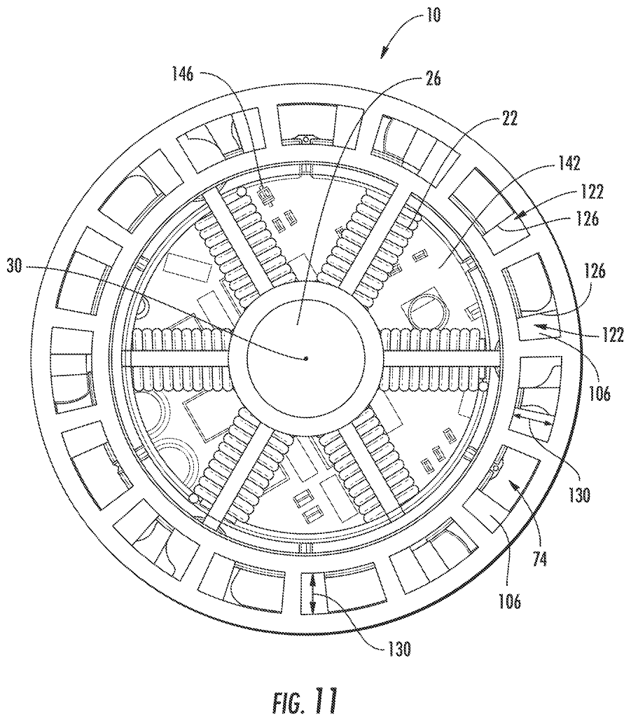

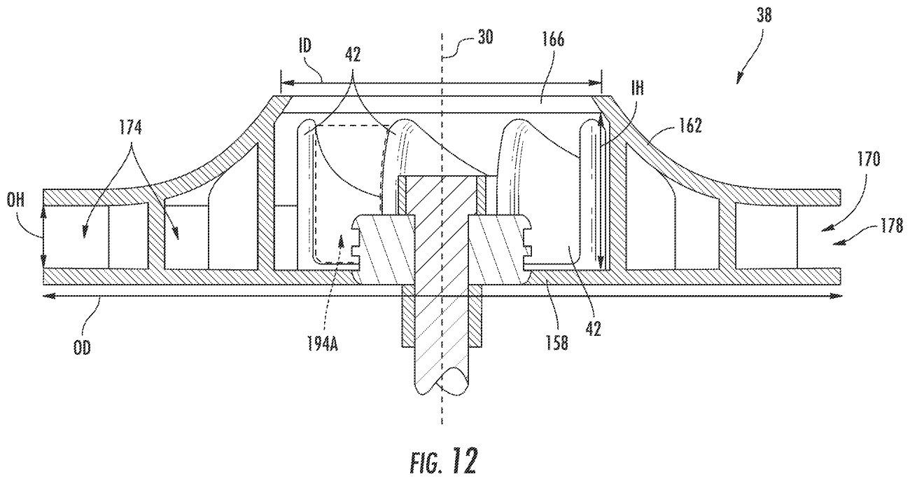

FIGS. 10 and 11 illustrate the radially inner surface 96, the radially outer surface 102, and the airflow channel 94 and the plurality of diffuser vanes 106 located within the airflow channel extending between the first wall 86 and the second wall 90. To control the length of the diffuser vanes, a diameter D1 of the radially inner surface 96 is between 75% and 85% of a diameter D2 of the radially outer surface 102. In one embodiment, the diameter D1 of the radially inner surface 96 is in a range between 80% and 85% of the diameter D2. In the illustrated embodiment, the diameter D1 is about 84% of the diameter D2. However, other ratios may be possible.

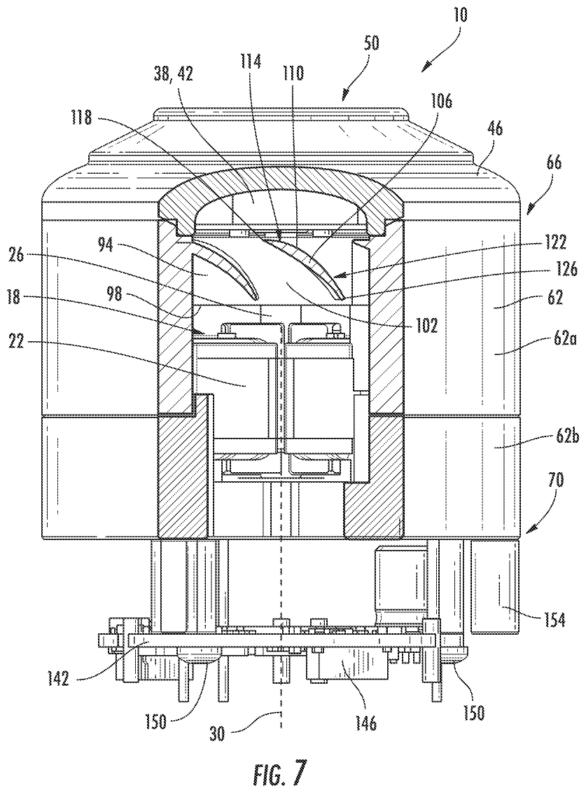

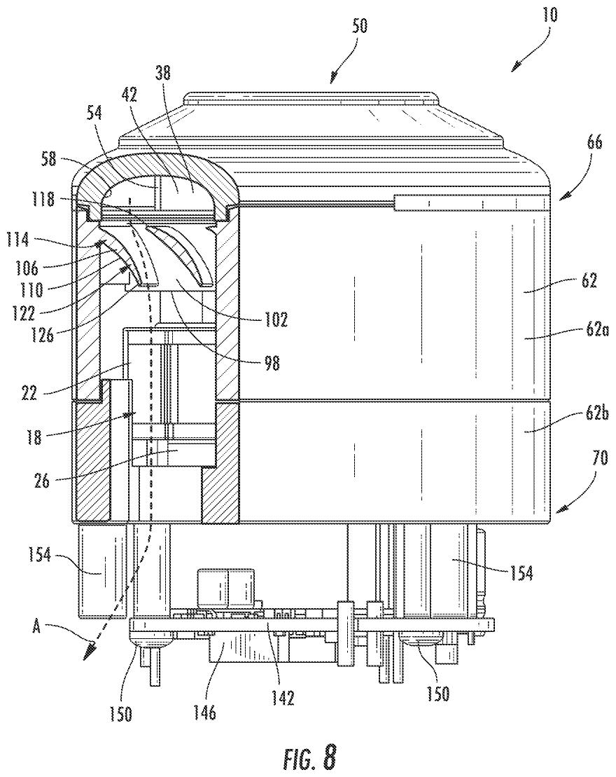

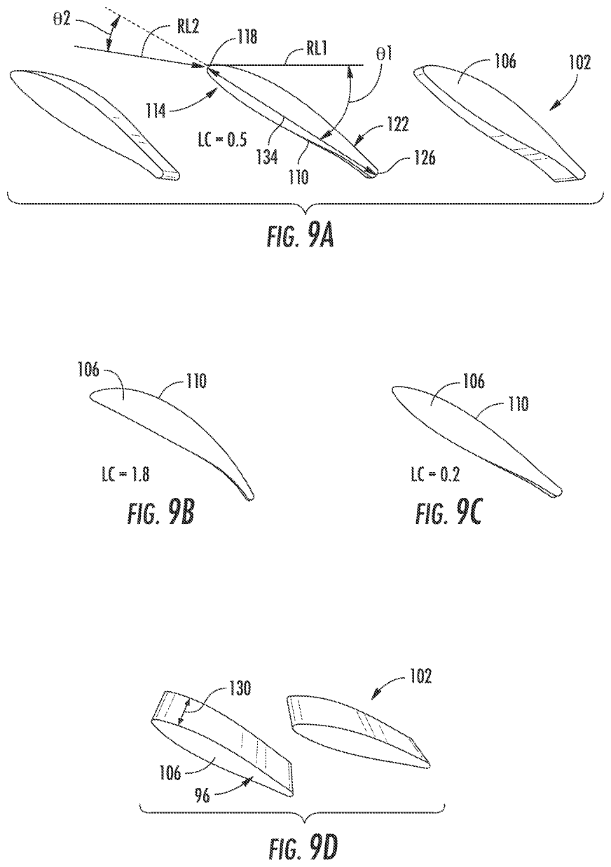

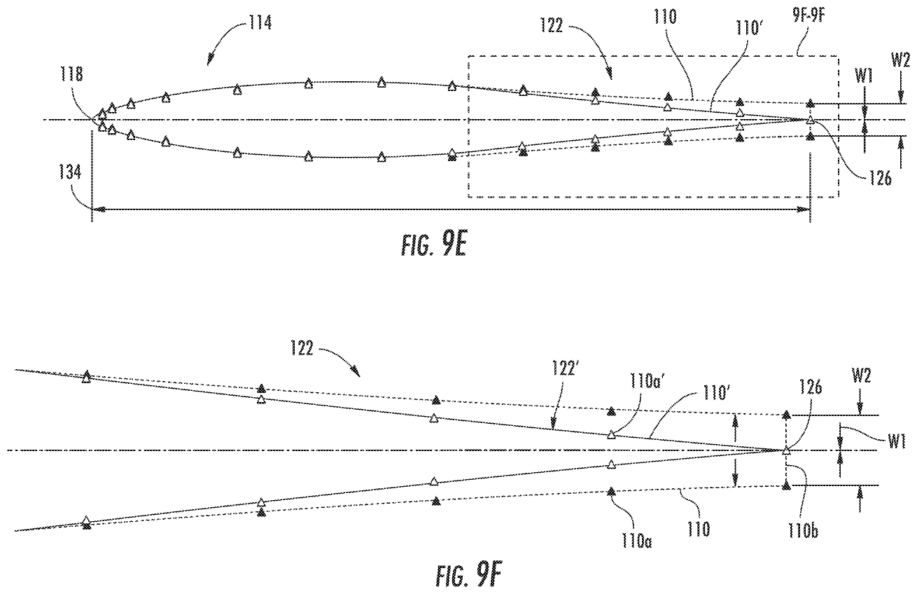

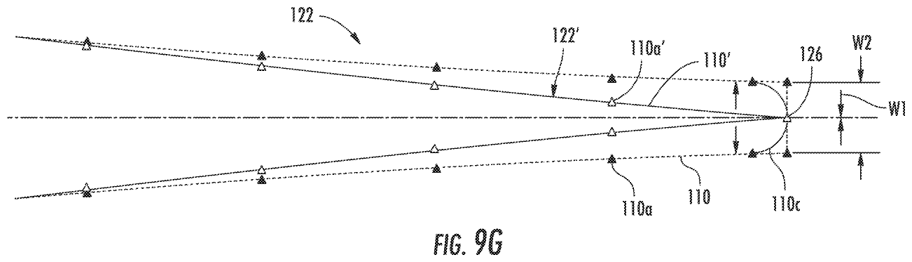

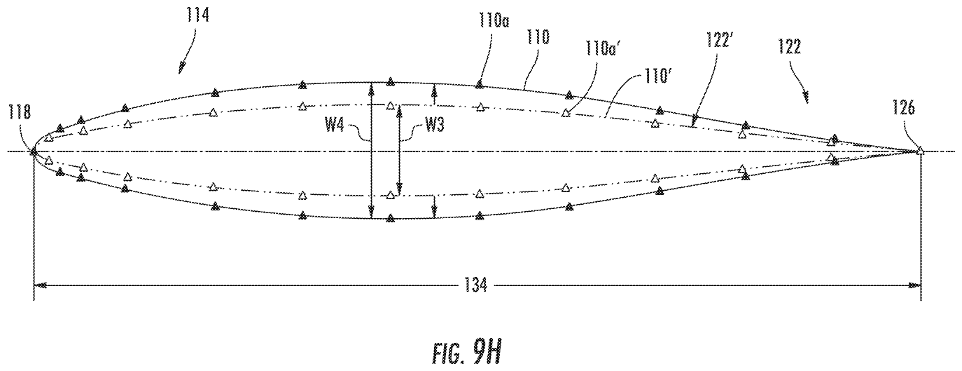

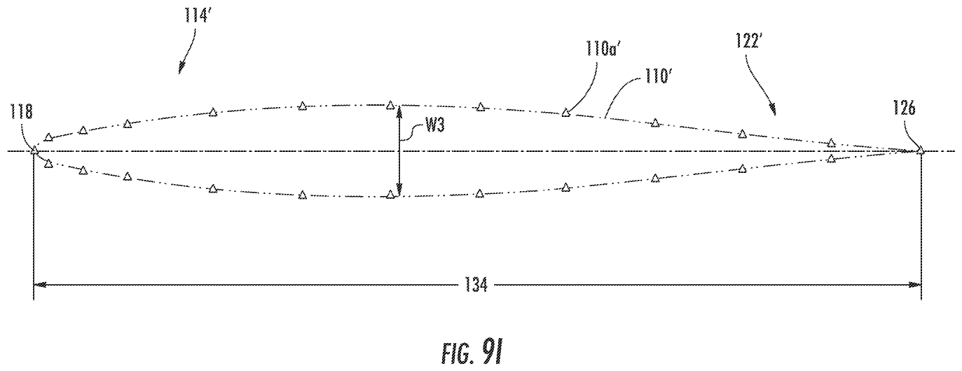

With reference to FIGS. 5 and 7, the motor housing 62 includes diffuser vanes 106 located within the airflow channel 94. The diffuser vanes 106 have a cross-sectional profile 110 with a leading edge portion 114 having a leading edge 118 adjacent the first end 66. As illustrated in FIG. 7, the cross-sectional profile 110 further includes a trailing edge portion 122 having a trailing edge 126 opposite the leading edge 118 and adjacent the intermediate point 98. In other words, the trailing edge 126 is between the first end 66 and the second end 70. The cross-sectional profile 110 of the diffuser vanes 106 extends radially from the longitudinal axis 30. In other words, the diffuser vanes 106 are radially extending diffuser vanes 106 with the leading edge 118 and the trailing edge 126 each extending radially from the longitudinal axis 30. Airflow passing through the airflow channel 94 passes along the diffuser vanes 106 and at least partially axially parallel to the longitudinal axis 30 in the interior 82 of the motor housing 62. In the illustrated embodiment, the diffuser vanes 106 are located in the airflow channel 94 with a width 130 (See FIGS. 9D, 10, 11) of the diffuser vane 106 extending between the radially inner surface 96 and the radially outer surface 102.

As illustrated in FIG. 8, upon operation of the motor 18, airflow generated by rotation of the impeller 38 (denoted by the dashed-line arrow A) passes through the airflow channel 94 and along the diffuser vanes 106. The airflow is then passed along the motor 18 prior to egress from the suction source 10 by the exhaust aperture 74.

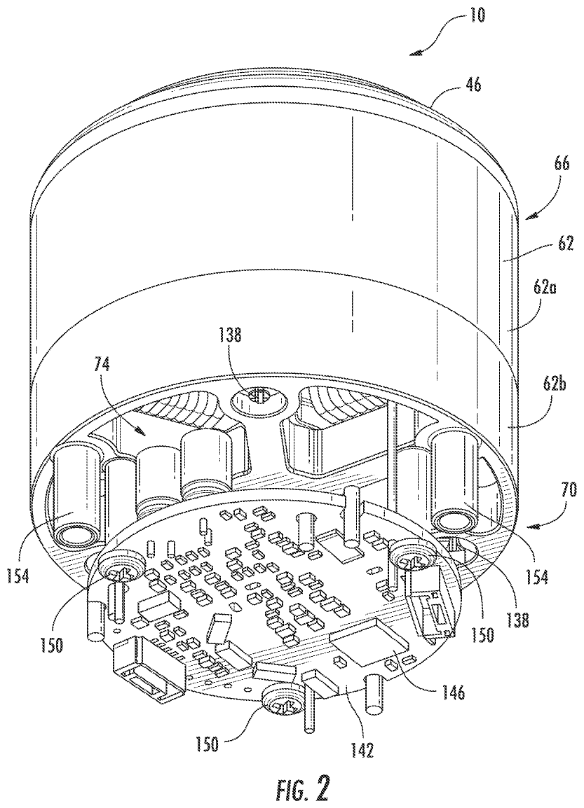

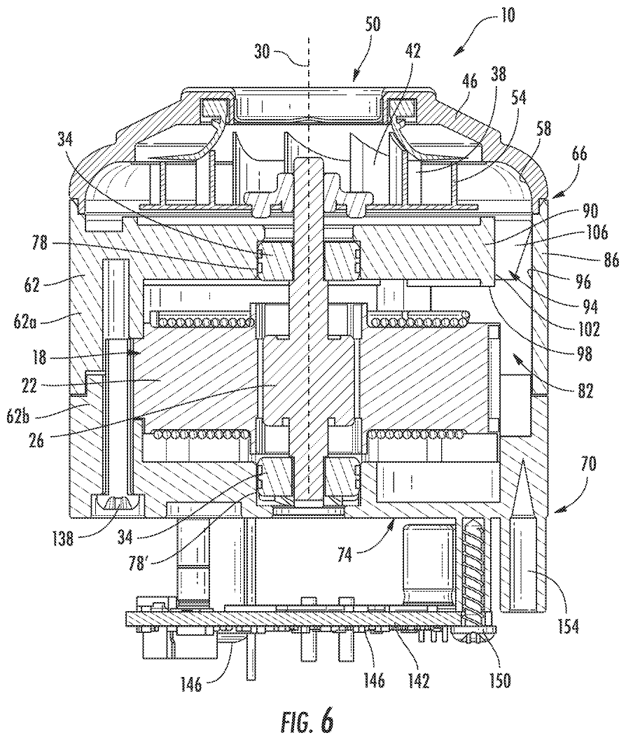

With reference to FIGS. 5 and 6, in the illustrated embodiment, the motor housing 62 includes a first motor housing piece 62a and a motor end housing piece 62b. The first motor housing piece 62a is adjacent the first end of the motor housing 62 and includes the diffuser vanes 106. The motor end housing piece 62b is adjacent the second end of the motor housing 62 and includes the lower bearing mount 78′ and the exhaust aperture 74. The suction source 10 includes a fastener 138 which secures the first motor housing piece 62a to the motor end housing piece 62b. As illustrated in FIG. 2, more than one fastener 138 is arranged circumferentially around the longitudinal axis to secure the first motor housing piece 62a to the motor end housing piece 62b.

Returning to FIG. 5, in some embodiments of the suction source 10, the first motor housing piece 62a is formed as an integral motor housing 62a in which the first end 66, upper bearing mount 78, an upper portion of the first wall 86, second wall 90, airflow channel 94, and diffuser vanes 106 are integrally formed as a single piece component. The integrally formed motor housing 62a connected to the motor end housing piece 62b further defines the interior 82 for passage of airflow from the first end 66 to the second end 70. The integrally formed motor housing 62a and the motor end housing 62b support the stator 22. The integral motor housing 62a further supports the rotor 26 through the upper bearing mount 78 and bearings 34. The motor end housing piece 62b supports the rotor 26 through the lower bearing mount 78′ and bearings 34.

With reference to FIGS. 9A-91, the diffuser vanes 106 have various parameters that may alter airflow through the airflow channel 94. First, as illustrated in FIGS. 9E and 9F, the diffuser vane 106 is a modified airfoil with the cross-sectional profile 110 of the diffuser vane 106 modified relative to a predetermined cross-sectional profile 110′ of an airfoil vane found in prior art diffuser vanes to include a thicker trailing edge portion 122. An illustrative prior art cross-sectional profile selected in one embodiment to be the predetermined cross-sectional profile 110′ is shown in FIG. 9I. For example, the prior art cross-sectional profile 110′ may correspond with an NACA (National Advisory Committee for Aeronautics) airfoil or any other predetermined airfoil. The prior art cross-sectional profile 110′ has a sharp trailing edge portion 122′ and a trailing edge 126. As viewed in the side view of FIG. 9I, the trailing edge 126 of the prior art cross-sectional profile 110′ is a point. As the prior art cross-sectional profile 110′ is extruded into or out of the page as viewed in FIG. 9I, the trailing edge 126 becomes an edge. The trailing edge 126 of the prior art cross-sectional profile 110′ is difficult to manufacture with consistency. The prior art cross-sectional profile 110′ also includes a width W1 that was generally sharp.

As best illustrated in FIG. 9H, the trailing edge portion 122 of the diffuser vane 106 is thickened relative to the predetermined sharp trailing edge portion 122′, and the cross-sectional profile 110 redefined to accommodate the thickened trailing edge portion 122. The cross-sectional profile 110 includes the thickened trailing edge portion 122 having a width W2 which is wider than the width W1. The width W1 and the width W2 extend substantially perpendicular from a chord 134 (FIGS. 9A, 9H) of the cross-sectional profile 110 and the prior art cross-sectional profile 110′, respectively. In one embodiment, the width W2 is greater than 2.5% of the chord length 134. In one embodiment, the width W2 is greater than 5% of the chord length 134. Such a thickened diffuser vane 106 trailing edge portion improves the manufacturing of the motor housing 62 which includes integrated diffuser vanes 106. Improved manufacturing of the motor housing 62 and diffuser vanes 106 results in reduced manufacturing costs and improved motor to motor consistency of airflow through the airflow channel 94.

With continued reference to FIG. 9H, both the prior art cross-sectional profile 110′ and the cross-sectional profile 110 are bounded by a plurality of spline points 110a, 110a′, respectively. The cross-sectional profile 110′ and the cross-sectional profile 110 also have a vane maximum thickness W3 and W4, respectively, substantially perpendicular to the chord 134. In modifying the spline points 110a′ of the prior art cross-sectional profile 110′, a length between each spline point 110a′ and the chord 134 is multiplied by a scale factor to increase the vane maximum thickness W3 of the prior art cross-sectional profile 110′ to the vane maximum thickness W4 of the cross-sectional profile 110. In one embodiment, the scale factor is between 1.0 and 2.0. In one embodiment, the scale factor is between 1.25 and 1.5. In the illustrated embodiment, the scale factor is 1.3. In one embodiment, the scale factor differs for different positions between the leading edge 118 and the trailing edge 126. Excluding the spline points 110a, 110a′ corresponding to the leading edge 118 and the trailing edge 126, each of the spline points 110a of the cross-sectional profile 110 are spaced further from the chord 134 in the cross-sectional profile 110 when compared to the prior art cross-sectional profile 110′ to maintain vane performance while thickening the trailing edge portion 122 to width W2.

With reference to FIGS. 9E and 9F, to achieve the thickened trailing edge width W2, the cross-sectional profile of the trailing edge portion 122 includes an expanded trailing edge 126 with a reference trailing surface 110b. The reference trailing surface 110b is provided adjacent the trailing edge 126 of the trailing edge portion 122. In one embodiment, the trailing edge portion 122 of the cross-sectional profile 110 is thickened to a W2 between 20% and 50% of the vane maximum thickness W4. In one embodiment, the trailing edge portion 122 is thickened to a W2 between 25% and 35% of the vane maximum thickness W4. Such a trailing edge 126 including trailing edge width W2 with a nonzero value as opposed to a more traditional trailing edge 126 improves the manufacturing of the diffuser vane 106 and improves the manufacturing of the motor housing 62 which includes integrated diffuser vanes 106. Improved manufacturing of the motor housing 62 and diffuser vanes 106 results in improved airflow through the airflow channel 94.

With reference to FIGS. 9A-C and G, the cross-sectional profile 110 may be provided with a rounded edge 110c adjacent the trailing edge 126. The rounded edge 110c may have a radius corresponding generally with the width W2 of the cross-sectional profile 110, the radius being provided to the trailing edge 126 above and below the chord 134. The rounded edge 110c may be otherwise provided to the trailing edge 126. The rounded edge 110c reduces losses in efficiency of the diffuser vanes 106 when compared to a planar trailing surface 110b.

As illustrated in FIG. 9A, the diffuser vane 106 includes a cross-sectional profile 110 having the chord 134 extending between the leading edge 118 and the trailing edge 126. In one embodiment, the length of the chord 134 (i.e., the chord length) between the leading edge 118 and the trailing edge 126 is between 5 mm and 20 mm. In one embodiment, the chord length between the leading edge 118 and the trailing edge 126 is between 10 mm and 15 mm. In one embodiment, to achieve optimum airflow through the airflow channel 94, the length of the chord 134 is 12 mm.

With continued reference to FIG. 9A, a chord angle Θ1 of the diffuser vane 106 taken between a line extending between the leading edge 118 and the trailing edge (i.e., between the chord 134) and a reference line RL1 which is perpendicular to the longitudinal axis 30 is between 35 and 50 degrees. In one embodiment, to achieve optimum airflow through the airflow channel 94, the chord angle @1 is 38 degrees. Another consideration for optimum airflow is the angle of attack Θ2 between the direction of incoming air RL2 and the chord 134.

As illustrated in FIGS. 9A-9C, the diffuser vane 106 may have a desired lift coefficient. The diffuser vanes 106 illustrated in FIG. 9A has lift coefficient of 0.5. The lift coefficient of the diffuser vane 106 illustrated in FIG. 9B is 1.8. The lift coefficient of the diffuser vane illustrated in FIG. 9C is 0.2. To achieve optimum airflow through the airflow channel 94, the lift coefficient of the diffuser vane 106 is between 0.1 and 2.4. In one embodiment, an optimum lift coefficient is 1.9.

Finally, with reference to FIGS. 10 and 11, the number of diffuser vanes 106 in the motor housing 62 may be altered. In one embodiment, the motor housing 62 includes from 6 to 24 diffuser vanes.

With continued reference to FIG. 2, a printed circuit board 142 is secured to the motor housing 62 beyond the second end of the motor housing 62. Control electronics 146 are mounted on the printed circuit board 142. The control electronics 146 are configured to send signals to the stator 22 to operate the motor 18. The control electronics 146 are also configured to receive signals from the vacuum cleaner 14 which indicate that the motor 18 should be operated. In one embodiment, the printed circuit board 142 is not secured to the motor housing 62 and instead installed in the vacuum cleaner or other application separate from the motor housing.

As illustrated in FIG. 6, circuit board fasteners 150 secure the printed circuit board 142 to the motor housing 62. The motor housing 62 also includes a fastener receiver 154 configured to receive a fastener of the vacuum cleaner 14 to secure the suction source 10 to the vacuum cleaner 14. As with the fasteners 138, suction source 10 may include a plurality of circumferentially, or otherwise, arranged circuit board fasteners 150 and fastener receivers 154.

With continued reference to FIGS. 2 and 6, the printed circuit board 142 is arranged adjacent the exhaust aperture 74 such that the exhaust aperture 74 permits egress of airflow generated by the impeller 38. The airflow outlet from the exhaust aperture 74 may pass along the printed circuit board 142 to carry heat generated by the control electronics 146 away from the printed circuit board 142.

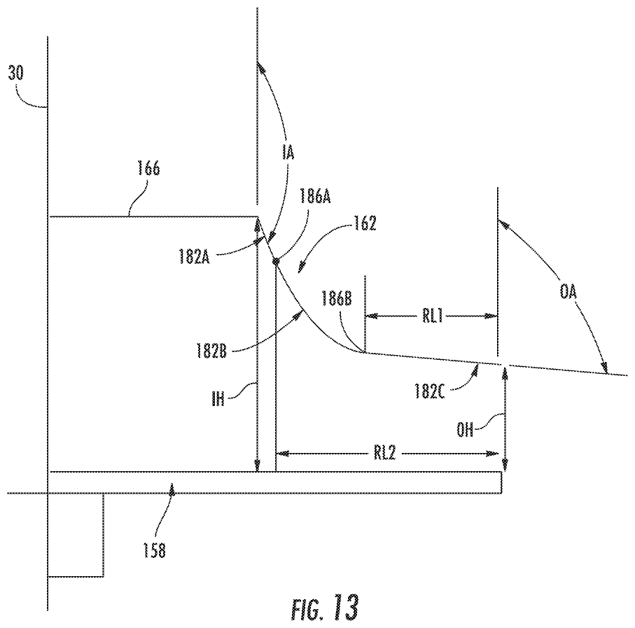

FIGS. 12 and 13 further illustrate the impeller 38. With reference to FIG. 12, the impeller 38 is provided with a hub 158, a shroud 162, and the blades 42 extending between and connected to the hub 158 and the shroud 162. The hub 158 extends to an outer diameter OD of the impeller 38. In the illustrated embodiment, the hub 158 is generally disc shaped. The impeller 38 is rotatable about the longitudinal axis 30 with the rotor 26.

With continued reference to FIG. 12, the shroud 162 of the impeller 38 opposes the hub 158. The shroud 162 defines an inlet aperture 166 about the axis 30 having an inlet diameter ID smaller than the outer diameter OD. In some embodiments, the inlet diameter ID is between 18 millimeters and 28 millimeters. In some embodiments, the outlet diameter OD is between 35 millimeters and 50 millimeters. In one embodiment, the inlet diameter ID is between 45% and 60% of the outer diameter OD. In one embodiment, the inlet diameter ID is between 45% and 55% of the outer diameter OD, or stated another way, about ½ of the outer diameter OD. In the illustrated embodiment, the inlet diameter ID is 21 mm and the outer diameter OD is 42 mm. The inlet aperture 166 is configured to receive fluid from the surroundings of the impeller 38. The shroud 162 extends to the outer diameter OD. The shroud 162 is offset from the hub 158 along the longitudinal axis 30 to define a passageway 170 between the hub 158 and the shroud 162 from the inlet aperture 166 to a circumferential outlet 178 at the outer diameter OD.

With continued reference to FIG. 12, the blades 42 divide the passageway 170 into a plurality of passages 174. As illustrated in FIGS. 10 and 12, each passage 174 is located between adjacent blades 42. Each passage 174 extends outwardly from the inlet aperture 166 towards the circumferential outlet 178 of the impeller 38. In the suction source 10, as viewed in FIG. 5, the circumferential outlet 178 exhausts fluid from the impeller 38 to the inner wall 58 of the cover 46. The blades 42 extend along the longitudinal axis 30 between the hub 158 and the shroud 162. An inlet height IH of the blades 42 measured between the hub 158 and the shroud 162 adjacent the inlet aperture 166 is greater than an outlet height OH of the blades 42 measured between the hub 158 and the shroud 162 adjacent the circumferential outlet 178. In some embodiments, the outlet height OH is between 40% and 85% of the inlet height IH. In one embodiment, the outlet height OH is between 40% and 60% of the inlet height IH. In the illustrated embodiment, the outlet height OH is about ½ of the inlet height IH. Each of the blades 42 curves along a circular arc. An arc center of each circular arc is parallel to but not collinear with the longitudinal axis 30.

As illustrated in FIG. 10, upon operation of the motor 18, the impeller 38 is rotated about the longitudinal axis 30 to generate an airflow extending along a flow path 190 between the inlet diameter ID and the outer diameter OD. The flow path 190 extends within each of the plurality of passages 174 between a blade 42 (of the plurality of blades 42), an adjacent blade 42 (of the plurality of blades 42), the hub 158, and the shroud 162 between the inlet aperture 166 (FIG. 12) and the circumferential outlet 178 (FIG. 12). As illustrated in FIG. 10, the distance between a blade 42 and an adjacent blade 42 perpendicular to the flow path 190 increases along the flow path 190 from the inlet aperture 166 (FIG. 12) to the circumferential outlet 178 (FIG. 12). A cross-sectional area 194 perpendicular to the flow path 190 increases along the flow path 190 from the inlet aperture 166 (FIG. 12) to the circumferential outlet 178 (FIG. 12). As viewed from FIG. 10, the cross-sectional area 194 is illustrated as a line between adjacent blades 42. The cross-sectional area 194 further extends between the hub 158 and the shroud 162 (i.e., into and out of the page as viewed from FIG. 10). As illustrated in FIG. 10, a cross-sectional area 194A is located adjacent the inlet aperture 166, and a cross-sectional area 194B is located adjacent the circumferential outlet 178. FIG. 12 further illustrates the cross-sectional area 194A between two of the blades 42. The cross-sectional area 194B is larger than the cross-sectional area 194A. In the illustrated embodiment, the cross-sectional area 194B is larger than the cross-sectional area 194A an amount corresponding to linear expansion and a length along the flow path 190 between the cross-sectional area 194A and the cross-sectional area 194B. In other words, each of the passages 174 are shaped as arcuate prisms with increasing cross-sectional area between the inlet aperture 166 and the circumferential outlet 178. The increasing cross-sectional area along the flow path forms expansion sections 182A, 182B, 182C within each of the plurality of passages 174.

FIG. 13 illustrates a partial side section view of the hub 158 and the inner surface of the shroud 162 and further illustrates a first expansion section 182A, a second expansion section 182B, and a third expansion section 182C. Each of the expansion sections 182A, 182B, 182C are generally defined by the profile of the inner surface of the shroud 162. The expansion sections 182A, 182B, 182C also generally correspond to differing and decreasing heights of the impeller 38 parallel to the longitudinal axis 30 as the cross-sectional area 194 of the passages 174 measured perpendicular to the flow path 190 increases along the flow path 190 between the inlet aperture 166 and the circumferential outlet 178.

The first expansion section 182A is adjacent the inlet aperture 166. In other words, the first expansion section 182A is radially closer to the inlet aperture 166 than either the second expansion section 182B or the third expansion section 182C.

The first expansion section 182A is linearly sloped in a direction extending from the inlet aperture 166 towards the circumferential outlet 178. As illustrated in FIG. 13, an inlet angle IA is located between the linearly sloped first expansion section 182A and the longitudinal axis 30. The inlet angle IA, in some embodiments, is between 140 and 170 degrees. In other embodiments, the inlet angle IA is between 150 and 165 degrees. In a preferred embodiment the inlet angle IA is 160 degrees.

The second expansion section 182B is positioned between the first expansion section 182A and the third expansion section 182C. A radially inner intersect point 186A is located between the first expansion section 182A and the second expansion section 182B. A radially outer intersect point 186B is located between the second expansion section 182B and the third expansion section 182C. The first expansion section 182A extends from the inlet aperture 166 to the radially inner intersect point 182A. The second expansion section 182B has a generally concave shape which is curved towards the hub 158 between the radially inner intersect point 186A and the radially outer intersect point 186B.

The third expansion section 182 is adjacent the circumferential outlet 178. In other words, the third expansion section 182C is radially closer to the circumferential outlet 178 than either the first expansion section 182A or the second expansion section 182B.

The third expansion section 182C is linearly sloped in a direction extending from the inlet aperture 166 towards the circumferential outlet 178. In other words, the third expansion section 182C is linearly sloped in a direction extending between the radially outer intersect point 186B and the circumferential outlet 178. As illustrated in FIG. 13, an outlet angle OA is located between the linearly sloped third expansion section 182C and the longitudinal axis 30. The outlet angle OA, in some embodiments, is greater than 90 and between 90 and 120 degrees. In other embodiments, the outlet angle OA is greater than 90 and between 90 and 105 degrees. The outlet angle OA, in some embodiments, is greater than 92 degrees from the longitudinal axis 30. In the illustrated embodiment, the outlet angle OA is 95 degrees from the longitudinal axis 30. In another expression of the outlet angle OA, the slope of the third expansion section 182C is greater than 2 degrees from perpendicular to the longitudinal axis 30.

As illustrated in FIG. 13, relative radial lengths of the expansion sections 182A, 182B, 182C impacts the geometry of the impeller 38, and may be manipulated to improve efficiency of the impeller 38. A first radial length RL1 is measured between the circumferential outlet 178 and the radially outer intersect point 186B. A second radial length RL2 is measured between the circumferential outlet 178 and the radially inner intersect point 186A. Radial length of the third expansion section 182C is bounded by the first and second radial lengths RL1, RL2, the inlet diameter ID, and the outlet diameter OD. In one embodiment, a ratio of the first radial length divided by the second radial length is between 50 and 70%. In another embodiment, the ratio of the first radial length RL1 divided by the second radial length RL2 is between 55% and 65%. In another aspect, a ratio of the second radial length RL2 divided by the outer diameter OD (FIG. 12) is between 18% and 25%. In another embodiment, the ratio of the second radial length RL2 divided by the outer diameter OD is between 20% and 23%.

As a result of the geometry of the blades 42 and the passages 174, the cross-sectional area 194 of the flow path 190 expands when viewed along the flow path 190 through the expansion sections 182A, 182B, 182C. In one embodiment, the cross-sectional area 194 of the flow path 190 measured perpendicular to the flow path expands linearly along the flow path 190 between the inlet aperture 166 and the circumferential outlet 178. In other words, the impeller 38 defines a linear expansion of the cross-sectional area 194 when viewed from a reference frame that is attached to the impeller 38. The linear expansion of the cross-sectional area 194 is a result of the combination of the shroud 162 having the described expansion sections 182A, 182B, 182C (FIG. 13) and the increase in spacing between adjacent blades 42 at increased radial distance from the longitudinal axis 30 (FIG. 10).

The cross-sectional area 194 has a height between the hub 158 and the shroud 162 which is parallel to the longitudinal axis 30. A height of the cross-sectional area 194A adjacent the inlet aperture has a first height generally corresponding to the blade inlet height IH and the cross-sectional area 194B adjacent the circumferential outlet 178 has a second height generally corresponding to the blade outlet height OH. The second height of the cross-sectional area 194B is less than the first height of the cross-sectional area 194A. Due to the curvature of the blade 42, the first radial length RL1, and the outlet angle OA, the cross-sectional area 194 increases linearly.

As illustrated in FIG. 10, each cross-sectional area 194 has a width taken perpendicular to the flow path 190 that extends in directions transverse to the longitudinal axis 30. The cross-sectional area 194A adjacent the inlet aperture has a first width and the cross-sectional area 194B adjacent the circumferential outlet 178 has a second width, and the second width of the cross-sectional area 194B is greater than the first width of the cross-sectional area 194A.

The profile of the shroud 162 including the described expansion sections 182A, 182B, 186C, allows for a more efficient impeller (when compared to known impellers) by slowing the relative velocity of the air passing through the fan passageways converting a portion of the kinetic energy of the air passing through the impeller to potential energy in the form of static pressure rise generated by the impeller 38. This increase in static pressure rise increases the efficiency of the impeller 38 and ultimately the suction source 10. This efficiency increase may be attributed at least in part to the decrease in velocity and a decrease in the amount of turbulent flow generated within the impeller 38 along the linearly increasing cross-sectional area 194 of the flow path 190. Impellers having non-linearly expanding passages 174 do not experience the same decrease in turbulent flow and increase in efficiency compared to the linearly expanding passages 174 of the impeller 38.

Although the disclosure has been described in detail with reference to certain preferred embodiments, variations and modifications exist within the scope and spirit of one or more independent aspects of the disclosure as described.

One or more independent features and/or advantages of the disclosure may be set forth in the following claims.

What is claimed is:

1. A suction source configured for use with a vacuum cleaner, a suction source comprising:
a motor including a stator and a rotor rotatable about a longitudinal axis relative to the stator by a bearing,
an impeller secured to the rotor,
a cover that houses the impeller,
a motor end housing having an exhaust aperture, and
an integrally formed motor housing connected to the motor end housing, the integrally formed motor housing including:
a first end fixed to the cover,
a bearing mount configured to receive the bearing therein and to permit rotation of the rotor relative to the stator,
a first wall extending along the longitudinal axis, the first wall having a radially inner surface,
a second wall extending along the longitudinal axis, the second wall having a radially outer surface facing the radially inner surface of the first wall,
an airflow channel defined between the radially inner surface of the first wall and the radially outer surface of the second wall, the airflow channel configured to pass airflow generated by the impeller from the first end towards a second end, and
a plurality of diffuser vanes located within the airflow channel extending between the first wall and the second wall such that, upon operation of the motor, airflow generated by rotation of the impeller passes through the airflow channel and along both the diffuser vane and the motor prior to egress from the suction source by the exhaust aperture adjacent the second end.

2. The suction source of claim 1, wherein the cover has an inner wall adjacent a radial periphery of the impeller, the inner wall configured to direct airflow generated by the impeller along the longitudinal axis towards the motor housing.

3. The suction source of claim 1, further comprising a printed circuit board secured to the motor housing beyond the second end of the motor housing and control electronics mounted on the printed circuit board, the control electronics configured to operate the motor.

4. The suction source of claim 3, wherein the exhaust aperture permits egress of the airflow generated by the impeller to pass along the printed circuit board to carry heat generated by the control electronics away from the printed circuit board.

5. The suction source of claim 1, wherein the plurality of diffuser vanes are located in the airflow channel with a width of each diffuser vane extending between the radially inner surface and the radially outer surface.

6. The suction source of claim 1, wherein a diameter of the radially outer surface between 75% and 85% of a diameter of the radially inner surface.

7. The suction source of claim 1, wherein each of the plurality of diffuser vanes has a lift coefficient between 0.1 and 2.4.

8. The suction source of claim 1, wherein the plurality of diffuser vanes includes from 6 to 24 diffuser vanes.

9. The suction source of claim 1, wherein the plurality of diffuser vanes each have a cross-sectional profile with a leading edge adjacent the first end and a trailing edge opposite the leading edge and between the first end and the second end.

10. The suction source of claim 9, wherein the plurality of diffuser vanes are radially extending each with the leading edge and the trailing edge extending radially from the longitudinal axis.

11. The suction source of claim 1, wherein the second wall has a proximal end adjacent the first end of the motor and a distal end spaced from the first end of the motor, and wherein the diffuser vanes are disposed between the proximal end and the distal end.

12. The suction source of claim 11, wherein the distal end of the second wall is disposed between the first end of the motor and the stator.

13. The suction source of claim 1, wherein the second wall is a cylindrical interior wall of the integrally formed motor housing concentric with the first wall.

14. The suction source of claim 9, wherein each of the plurality of diffuser vanes is a modified airfoil having a chord and a vane maximum thickness substantially perpendicular to the chord, wherein a trailing edge portion includes a width W2 between 20% and 50% of the vane maximum thickness, and more particularly between 25% and 35% of the vane maximum thickness.

15. A suction source configured for use with a vacuum cleaner, the suction source comprising:
a motor including a stator and a rotor rotatable about a longitudinal axis relative to the stator,
an impeller secured to the rotor,
a cover that houses the impeller, and
a motor housing including,
a first end fixed to the cover,
a second end opposite the first end, the second end having an exhaust aperture,
a first wall extending along the longitudinal axis, the first wall having a radially inner surface,
a second wall extending along the longitudinal axis, the second wall having a radially outer surface facing the radially inner surface of the first wall,
an airflow channel defined between the radially inner surface of the first wall and the radially outer surface of the second wall, the airflow channel configured to pass airflow generated by the impeller from the first end towards the second end, and
a diffuser vane located within the airflow channel such that, upon operation of the motor, airflow generated by rotation of the impeller passes through the airflow channel and along both the diffuser vane and the motor prior to egress from the suction source by the exhaust aperture;
wherein the diffuser vane has a cross-sectional profile with a leading edge portion having a leading edge adjacent the first end and a trailing edge portion having a trailing edge opposite the leading edge, the leading edge and trailing edge defining a chord therebetween, and
wherein the cross-sectional profile of the diffuser vane includes a vane maximum thickness substantially perpendicular to the chord, wherein the trailing edge portion includes a width between 20% and 50% of the vane maximum thickness.

16. The suction source of claim 15, wherein the cross-sectional profile includes a width between 25% and 35% of the vane maximum thickness.

17. The suction source of claim 15, wherein the chord forms a chord angle relative to a reference line perpendicular to the longitudinal axis between 35 degrees and 50 degrees.

18. The suction source of claim 15, wherein a chord length of the diffuser vane between the leading edge and the trailing edge is between 5 millimeters and 20 millimeters.

19-33. (canceled)
